(19) United States
(12) Patent Application Publication
(10) Pub. No.: US 2007/0054058 A1
(43) Pub. Date: Mar. 8, 2007

(54) Surface treatment system

(76) Inventors: Lee E. Starcevich, Glendale, AZ (US); John R. Spencer, Rio Verde, AZ (US)

Correspondence Address: NEUSTEL LAW OFFICES, LTD., 2534 SOUTH UNIVERSITY DRIVE, SUITE 4, FARGO, ND, 58103, US

(21) Appl. No.: 11/221,320

(22) Filed: Sep. 6, 2005

(51) Int. Cl. B05C 5/00; B05B 7/06; B05D 1/02

(52) U.S. Cl. 427/421.1; 427/299; 427/372.2; 118/313; 118/324

(57) ABSTRACT

A surface treatment system for preparing a natural or artificial stone surface for a spray application and applying a protective barrier to the surface. The surface treatment system includes a conveyor that transports product past a plurality of spray activation switches that control spray heads which apply a liquid spray. A vacuum unit positioned above a section of the conveyor includes a brush and debris tube for cleaning the product prior to the liquid application. A dryer unit surrounds a length of the conveyor after the spray heads and utilizes heated forced air from a blower to speed the curing process of the applied liquid.

### STATEMENT REGARDING FEDERALLY SPONSORED RESEARCH OR DEVELOPMENT

Not applicable to this application.

### CROSS REFERENCE TO RELATED APPLICATIONS

Not applicable to this application.

### BACKGROUND OF THE INVENTION

1. Field of the Invention

The present invention relates generally to stone surfacing devices and more specifically it relates to a surface treatment system for preparing a natural or artificial stone surface for a spray application and applying a protective barrier to the surface.

2. Description of the Related Art

Any discussion of the prior art throughout the specification should in no way be considered as an admission that such prior art is widely known or forms part of common general knowledge in the field.

Stone surfacing devices have been in use for years. Typically, stone tiles or bricks are finished with environmental barrier treatments after installation at the particular site. Some automated treatment systems utilize a conveyor to transport stone tiles through a process of cleaning, liquid application and drying. However, the automated systems in use today do not provide a means of applying different surface treatments at the same time to different stone tiles on the conveyor.

While these devices may be suitable for the particular purpose to which they address, they are not as suitable for preparing a natural or artificial stone surface for a spray application and applying a protective barrier to the surface. Current automated surface treatment systems are only capable of applying a single liquid treatment at a time.

In these respects, the surface treatment system according to the present invention substantially departs from the conventional concepts and designs of the prior art, and in so doing provides an apparatus primarily developed for the purpose of preparing a natural or artificial stone surface for a spray application and applying a protective barrier to the surface.

### BRIEF SUMMARY OF THE INVENTION

In view of the foregoing disadvantages inherent in the known types of stone surfacing devices now present in the prior art, the present invention provides a new surface treatment system construction wherein the same can be utilized for preparing a natural or artificial stone surface for a spray application and applying a protective barrier to the surface.

The general purpose of the present invention, which will be described subsequently in greater detail, is to provide a new surface treatment system that has many of the advantages of the stone surfacing devices mentioned heretofore and many novel features that result in a new surface treatment system which is not anticipated, rendered obvious, suggested, or even implied by any of the prior art stone surfacing devices, either alone or in any combination thereof.

To attain this, the present invention generally comprises a first conveyor that transports untreated product past a vacuum unit with a brush and to a booth and a second conveyor that transports treated product from the booth to a dryer unit for finishing. The vacuum unit cleans a surface of the untreated product by utilizing the brush in preparation for the application of a liquid from spray heads in the booth. The dryer unit utilizes heated forced air from a blower to speed the curing process of the liquid applied to the cleaned product.

There has thus been outlined, rather broadly, the more important features of the invention in order that the detailed description thereof may be better understood, and in order that the present contribution to the art may be better appreciated. There are additional features of the invention that will be described hereinafter and that will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

A primary object of the present invention is to provide a surface treatment system that will overcome the shortcomings of the prior art devices.

A second object is to provide a surface treatment system for preparing a natural or artificial stone surface for a spray application and applying a protective barrier to the surface.

Another object is to provide a surface treatment system that increases stone tile environmental resistance.

An additional object is to provide a surface treatment system that improves stone tile stain resistance.

A further object is to provide a surface treatment system that improves the efficiency of applying a barrier solution to stone tiles and the like.

Another object is to provide a surface treatment system that allows multiple solutions to be applied to different stone tiles at the same time.

Other objects and advantages of the present invention will become obvious to the reader and it is intended that these objects and advantages are within the scope of the present invention.

To the accomplishment of the above and related objects, this invention may be embodied in the form illustrated in the accompanying drawings, attention being called to the fact, however, that the drawings are illustrative only, and that changes may be made in the specific construction illustrated and described within the scope of the appended claims.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is an upper perspective view of the present invention.

FIG. 2 is a side view of the present invention.

FIG. 3 is an upper perspective view of the first and second conveyors.

FIG. 4a is an upper perspective view of the first conveyor and vacuum unit.

FIG. 4b is a magnified view of the brush cleaning untreated product.

FIG. 5a is an upper perspective view of the conveyor transition and booth.

FIG. 5b is a magnified upper perspective view of the conveyor transition, booth and spray activation switches.

FIG. 6 is an upper perspective view of the second conveyor and drying process.

### DETAILED DESCRIPTION OF THE INVENTION

A. Overview

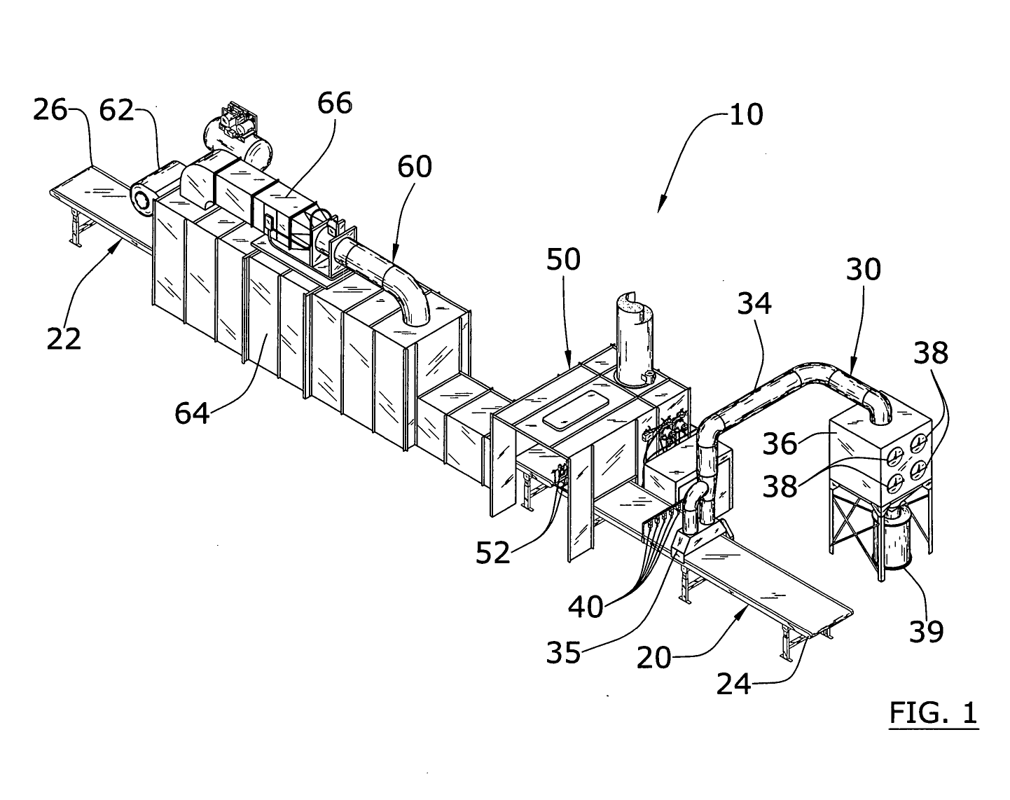

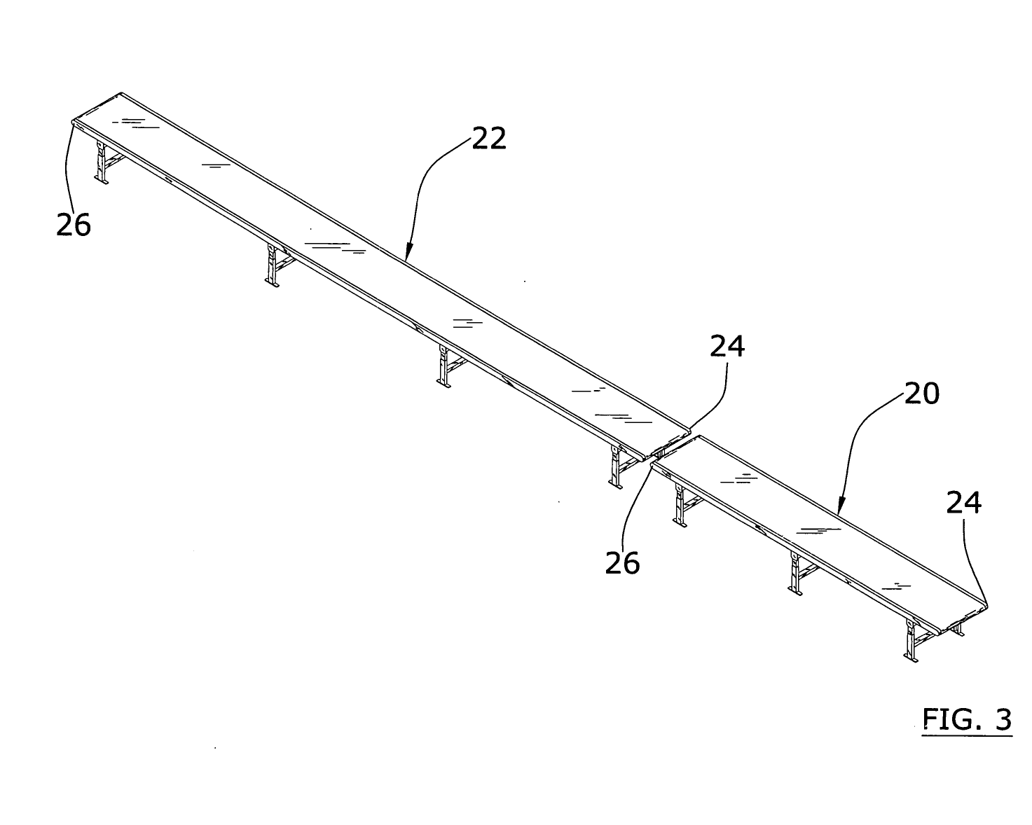

Turning now descriptively to the drawings, in which similar reference characters denote similar elements throughout the several views, FIGS. 1 through 6 illustrate a surface treatment system 10, which comprises a first conveyor 20 and second conveyor 22 that transports product 12, 14, 16, 18 past a plurality of spray activation switches 40 that control spray heads 52 which apply a liquid 54 spray. A vacuum unit 30 positioned above a section of the first conveyor 20 includes a brush 32 and debris tube 34 for cleaning the untreated product 12 prior to the liquid 54 application. A dryer unit 60 surrounds a length of the second conveyor 22 after the spray heads 52 and utilizes heated forced air from a blower 62 to speed the curing process of the applied liquid 54.

B. Conveyor

The conveying system is preferably comprised of a first conveyor 20 and second conveyor 22 separately driven by individual motors located on each conveyor 20, 22, however it can be appreciated by one skilled in the art that a single conveyor could be utilized. The conveyor 20, 22 structures are constructed of metal, preferably steel, where a plurality of support extensions elevate the conveyor surfaces to the desired height. The width of the conveyor 20, 22 structures are approximately 40 inches, while the belt widths are approximately 36 inches. However, it can be appreciated that other conveyor 20, 22 structure widths and belt widths could be utilized to accommodate various sized product 12, 14, 16, 18. The belt material is preferably constructed of material that can withstand liquids 54 (e.g. stain or moisture barrier) and the normal cyclical lifetime of conveyors belts. Additionally, the belt material is also preferably constructed of material which will withstand the rough texture of the product 12, 14, 16, 18 placed on it.

As shown in FIGS. 1 through 4a, the first conveyor 20 is approximately 20 feet in length, but it can be appreciated that varying lengths could be utilized for different product. The start end 24 of the first conveyor 20 is used for loading untreated product 12 (e.g. stone tile, pavers) and is supported to withstand the loading process. The start end 24 of the first conveyor 20 has a fixed drive roller and bearings while the return end 26 has an adjustable idler for tightening of the belt.

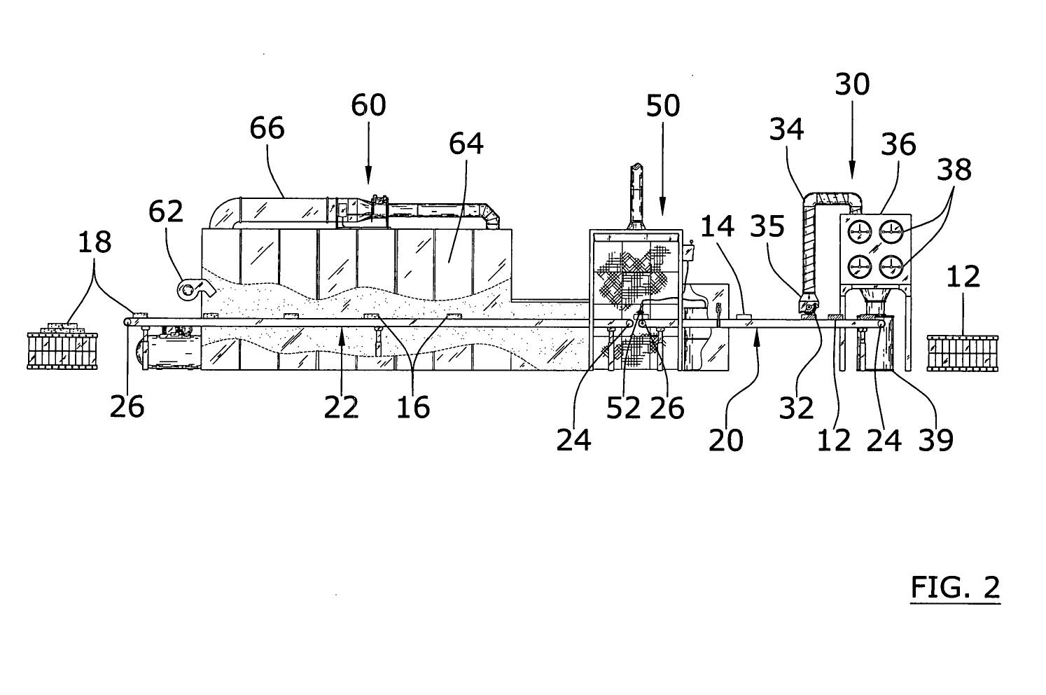

As shown in FIGS. 2, 3 and 6, the second conveyor 22 is approximately 40 feet in length, but it can be appreciated that varying lengths could be utilized for different product. The start end 24 of the second conveyor 22 is used for receiving the treated product 16 from the first conveyor 20. The start end 24 of the first conveyor 20 has an adjustable idler for tightening of the belt while the return end 26 has a fixed drive roller and bearings.

C. Vacuum Unit

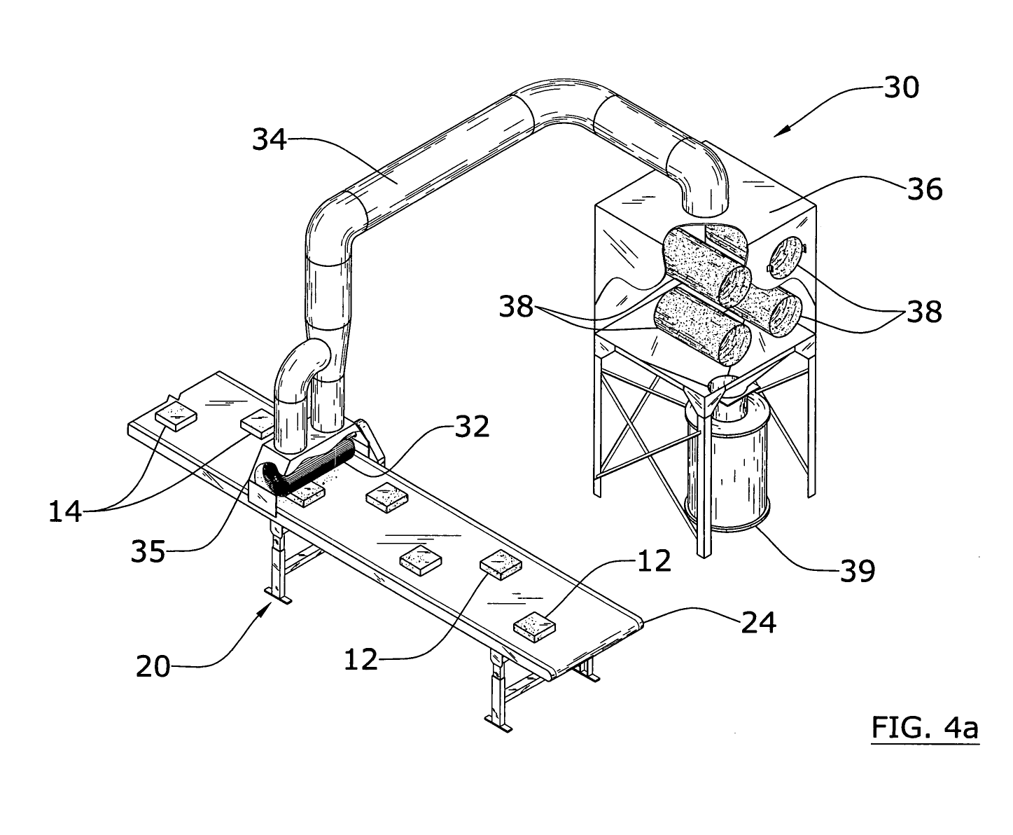

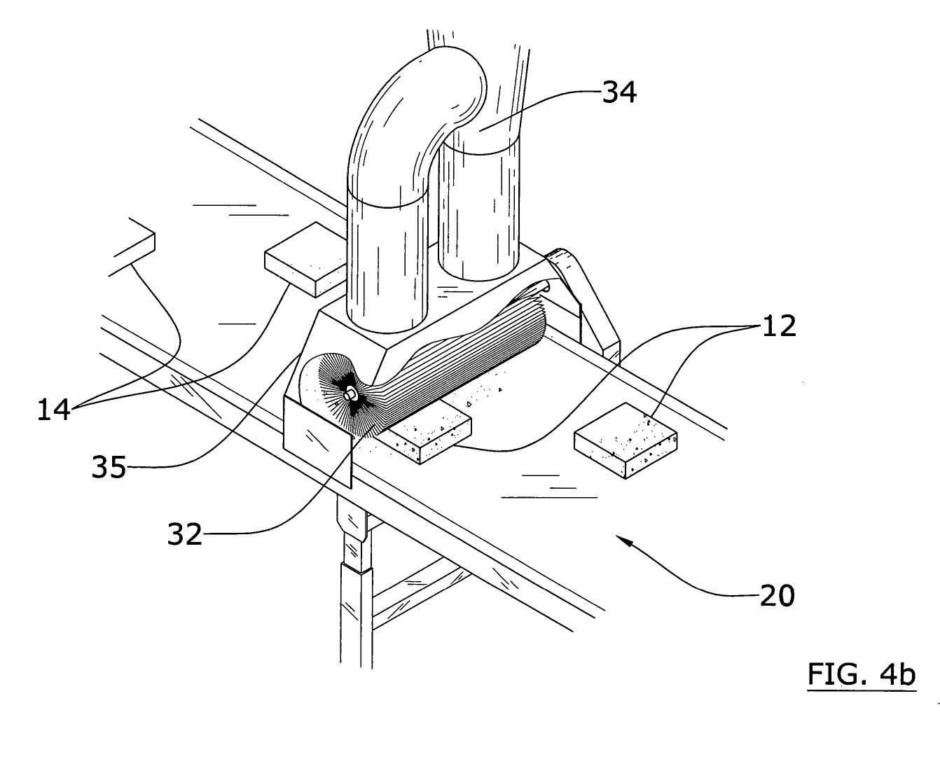

The vacuum unit 30 is comprised of a vacuum element 36 containing a plurality of filters 38, a brush 32 connected to the vacuum element 36 by a debris tube 34 and a collection drum 39. A hood 35 is located at the inlet of the debris tube 34 which supports the brush 32 over a section of the first conveyor 20 as best shown in FIGS. 4a and 4b.

The vacuum element 36 is comprised of an industrial vacuum and container. The container has an inlet in which the debris tube 34, enters and an outlet in which the collection drum 39 connects as best shown in FIG. 4a. The container portion houses the filters 38 used in the cleaning process surface treatment system 10. As shown in FIGS. 1, 2 and 4a, preferably four filters 38 aligned parallel to one another in a square configuration are utilized. However, it can be appreciated by one skilled in the art, that different configurations and numbers of filters 38 could be utilized. The filters 38 collect the dust particles and the like as a result of the brush 32 rotation acting on the untreated product advancing down the first conveyor 20. The filters 38 are preferably removable from the container for cleaning or replacement.

The brush 32 used to clean the untreated product 12 is preferably cylindrical in shape, spanning the width of the selected belt as best shown in FIGS. 4a and 4b. As viewed in FIGS. 4a and 4b, the brush 32 rotates counter clockwise or opposite the direction of the belt movement. The brush 32 bristles are preferably constructed of a highly wear resistant material to withstand the contact with the untreated product 12. The brush 32 is preferably positioned tangent to the first conveyor's 20 belt, nearly touching the surface of the belt.

As best shown in FIGS. 1, 2 and 4a, the debris tube 34 spans from the first conveyor 20 to the vacuum element 36. The hood 35, as best shown in FIGS. 4a and 4b is located at the inlet of the debris tube 34 spans the width of the conveyor 20, contains and supports the brush 32 and protects the area from flying debris (e.g. small stones) as a result of the brush 32 rotation. The debris tube 34 is used to contain and transport the dust and debris removed from the untreated product 12 by the rotation of the brush 32.

As illustrated in FIGS. 1, 2 and 4a, the collection drum 39 is located at the outlet of the vacuum element 36. The collection drum 39 receives the particles that are too large (e.g. small stones) to be held by the filters 38 located in the container portion of the vacuum element 36. The collection drum 39 is also preferably easily removable and handled in order to empty the contents once full.

D. Booth

The booth 50 encompasses a spray area, filter system, controls and liquid 54 containers. The spray area and filter system is an enclosed area covering a portion of the first conveyor 20, used for applying the liquid 54 barrier to a cleaned product 14. A cleaned product 14 is (e.g. stone tile or paver block) being transported on the first conveyor 20 that has passed through the vacuum unit 30.

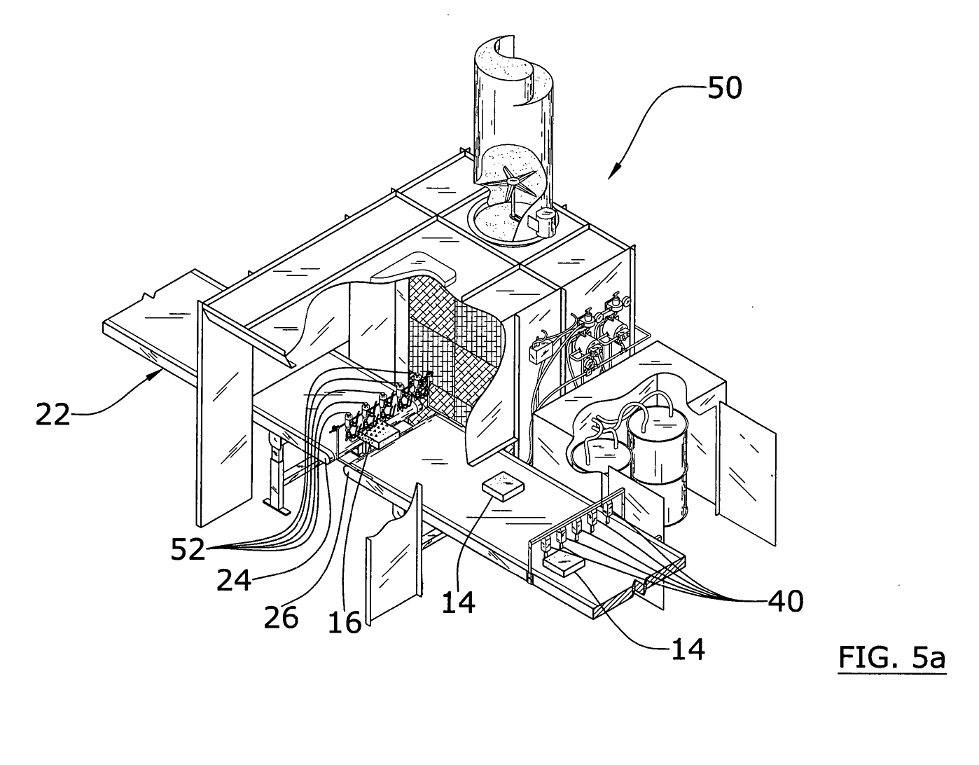

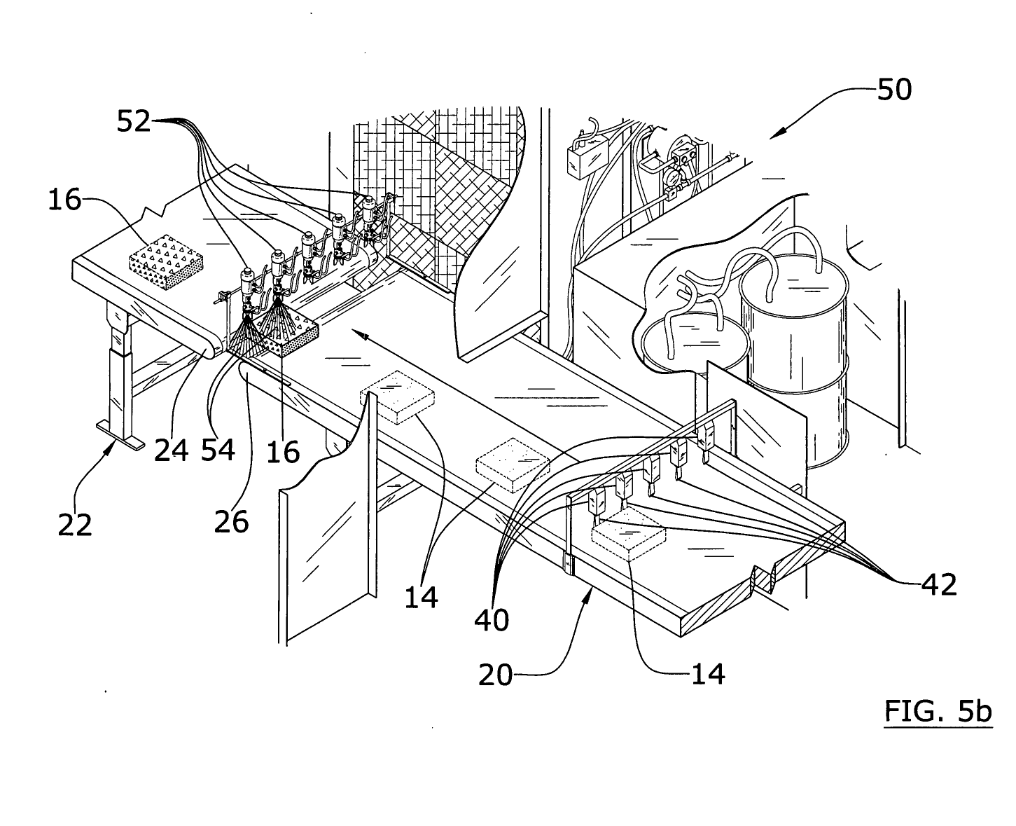

As best shown in FIGS. 5a and 5b, a series of spray heads 52 preferably span the width of the first conveyor 20 within the spray area of the booth 50. The spray heads 52 are preferably equally spaced from one another and are vertically positioned above the belt surface of the first conveyor 20 at a height slightly above the cleaned product 14. The spray heads 52 are connected to the liquid 54 containers by supply lines. Each spray head 52 is preferably capable of individually discharging a different liquid 54 than the other spray heads 52 or discharging the same liquid as the other spray heads 52. The spray heads 52 are preferably adjustable to allow for varying spray widths of liquid 54 and are preferably positioned between the transition of the return end 26 of the first conveyor 20 and the start end 24 of the second conveyor 22.

Further shown in FIGS. 1, 5a and 5b a series of spray activation switches 40 preferably span the width of the first conveyor 20, located prior to the booth 50 as the direction of the first conveyor 20 moves. The spray activation switches 40 are preferably equally spaced from one another and are vertically positioned above the belt surface of the first conveyor 20. Located on each spray activation switch 40 is an actuator 42 positioned at a height to contact a cleaned product 14 as it passes on the first conveyor 20. Each spray activation switch 40 is preferably aligned with a spray head 52 located in the booth 50. The spray activation switches 40 are used to activate or signal each individual spray head 52 that a cleaned product 14 is moving on the first conveyor 20 ready for liquid 54 application.

E. Dryer Unit

The dryer unit 60 is comprised of a drying compartment 64 extending along a length of the second conveyor 22, a blower 62 and recirculation duct 66 extending along the length of the drying compartment 64. The dryer unit 60 is used to expedite the curing process of the treated product 16 after it leaves the booth 50. The dryer unit 60 components 62, 64, 66 are preferably made of sheet metal material, preferably steel.

As best shown in FIGS. 1, 2 and 6, the drying compartment 64 substantially encloses a length of the second conveyor 22, starting from ground level to height of approximately 4 feet above the second conveyor 22. The drying compartment 64 extends along the second conveyor 22 from near the exit of the booth 50 to near the return end 26 of the second conveyor 22.

As further illustrated in FIGS. 1, 2 and 6, a blower 62 and recirculation duct 66 attach to the top of the drying compartment 64. The blower 62 forces heated air at a predetermined temperature into the drying compartment 64 of the surface treatment system 10 and is circulated by means of the recirculation duct 66 in a counter clockwise rotation. The temperature of the forced air from the blower 62 is determined by the liquid 54 used to treat the product 16.

F. Operation of the Invention

In use, the surface treatment system 10 is preferably used for applying liquid 54 barriers (e.g. sealants) to stone tiles, paver blocks and the like. However, it can be appreciated that the surface treatment system 10 can be utilized for applying liquid 54 barriers to any similar porous surfaces such as travertine, slate, quartz, limestone and other similar materials, natural or imitation. In addition, the liquid 54 may be comprised of other chemicals for cleaning and providing other conditioning effects.

After selecting the product to be used, the desired liquid 54 application (e.g. stain, moisture resistance) needs to be determined. With the liquid 54 selected, the booth 50 can be prepared with the appropriate containers and the dryer unit 60 temperature set to the correct curing temperature.

As shown in FIGS. 1, 2 and 4a, the untreated product 12 is placed onto the start end 24 of the first conveyor 20 which is moving in a counter clockwise rotation as shown. The untreated product 12 can be positioned in any manner, but for efficiency, the preferred orientation is square with the first conveyor 20 as shown in FIGS. 4a and 4b.

The next stage of the surface treatment system 10 is the cleaning process as best shown in FIGS. 4a and 4b. As the untreated product 12 is transported by the first conveyor 20, it first encounters the vacuum unit 30 having a brush 32 rotating opposite of the first conveyor 20 and attached to the hood 35 of the debris tube 34. The brush 32 removes dust particles and loose stones from the untreated product 12 and in turn, the vacuum element 36 draws the removed debris through the debris tube 34 into the vacuum element 36. Located within the vacuum element 36, filters 38 absorb the removed dust particles while heavier stones and particles drop through the vacuum element 36 into the collection drum 39.

As best shown in FIGS. 5a and 5b, as the now cleaned product 14 leaves the vacuum unit 30, the next stage of the surface treatment system 10 is the liquid 54 application stage. As the cleaned product 14 passes the brush 32, it approaches the spray activation switches 40. The spray activation switches 40 by means of an actuator 42 signal spray heads 52 located in the booth 50 as to the coming of cleaned product 14. Each spray activation switch 40 is electronically connected to a corresponding spray head 52, so only those spray heads 52 required to spray liquid 54 will, resulting in less liquid 54 waste.

The spray heads 52 are located at the transition between the first conveyor 20 and second conveyor 22 within the booth 50 as shown in FIGS. 5a and 5b. As the treated product 16 transitions off the return end 24 of the first conveyor 20 it lands onto the start end 26 of the second conveyor 22 which is moving in the same direction. The treated product 16 then exits the booth 50 and approaches the final stage of the surface treatment system 10, the dryer unit 60.

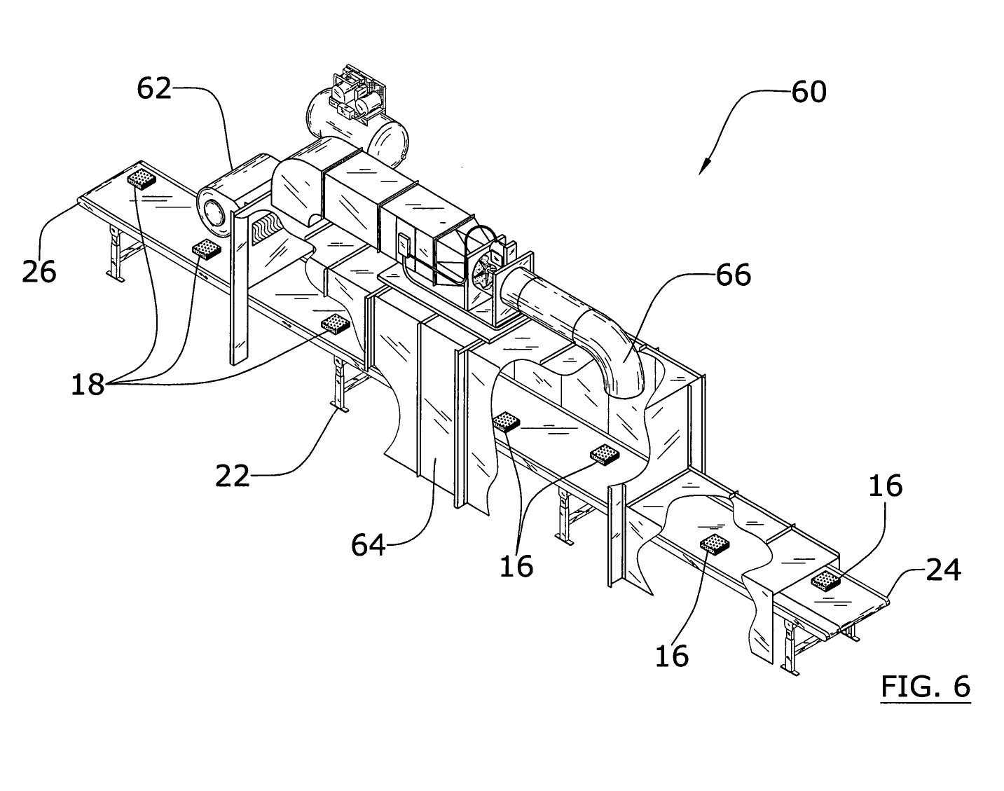

As shown in FIG. 6, within the dryer unit 60 heated forced air recirculates within the drying compartment surrounding the second conveyor 22. The recirculating air reduces the amount of time required for curing and drying of the liquid 54 applied to the treated product 16. The speed of the second conveyor 22 transporting the treated product 16 and the temperature of the forced air can be adjusted to change for varying liquid 54 curing times. As best shown in FIGS. 2 and 6, a finished product 18 (cured) exits the dryer unit 60 and approaches the return end 26 of the second conveyor 22 for removal from the surface treatment system 10 and shipment preparation.

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

We claim:

1. A surface treatment system, comprising:
a conveyor having a start end and a return end;
a plurality of spray heads positioned above said conveyor for spraying a liquid upon objects carried upon said conveyor; and
a plurality of spray activation switches positioned above said conveyor for detecting a position of an object carried upon said conveyor, wherein each of said spray activation switches control at least one of said spray heads.

2. The surface treatment system of claim 1, wherein said spray activation switches are positioned between said start end and said spray heads.

4. The surface treatment system of claim 1, wherein said spray activation switches and said spray heads are adjustably positioned with respect to said conveyor.

5. The surface treatment system of claim 1, wherein said spray activation switches and said spray heads are substantially equally spaced across said conveyor.

6. The surface treatment system of claim 1, wherein said spray heads are contained within a booth.

7. The surface treatment system of claim 1, wherein each of said spray heads can discharge a different liquid spray.

8. The surface treatment system of claim 1, including a vacuum unit positioned above said conveyor, wherein said vacuum unit is positioned between said start end and said spray heads.

9. The surface treatment system of claim 8, wherein said vacuum unit is comprised of:
a vacuum element having an inlet and an outlet;
a brush attached to a debris tube, wherein said brush lies perpendicular to said conveyor, wherein said brush lies substantially tangent to said conveyor, and wherein said debris tube connects to said inlet of said vacuum element;
a plurality of filters attached within said vacuum element; and
a collection drum connected to said outlet of said vacuum element.

10. The surface treatment system of claim 1, including a dryer unit positioned above said conveyor, wherein said dryer unit is positioned between said spray heads and said return end.

11. The surface treatment system of claim 10, wherein said dryer unit is comprised of:
a drying compartment extending along said conveyor;
a blower attached to said drying compartment; and
a recirculation duct extending along said drying compartment, wherein said recirculation duct is connected to said blower and said drying compartment.

12. A method of treating a surface, said method comprising the steps of:
positioning an object upon a conveyor;
transporting said object on said conveyor;
cleaning said object;
vacuuming said object;
applying a liquid spray to said object;
drying said object; and
removing said object from said conveyor.

13. A method of treating a surface, said method comprising the steps of:
positioning an object upon a conveyor;
transporting said object on said conveyor;
determining a location of said object upon said conveyor;
activating one or more spray heads that correspond to said location of said object upon said conveyor for spraying said object; and
removing said object from said conveyor.
